(19) United States
(12) Patent Application Publication
(10) Pub. No.: US 2007/0144066 A1
(43) Pub. Date: Jun. 28, 2007

(54) Defensive anti-intrusion vegetal hedge and method for the production thereof

(75) Inventor: Daniel Soupe, Chatillon sur Chalaronne (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sinnoveg, Chatillon sur Chalaronne (FR)

(21) Appl. No.: 10/582,942

(22) PCT Filed: Dec. 13, 2004
(86) PCT No.: PCT/FR04/50683

§ 371 Date: Jun. 15, 2006

(30) Foreign Application Priority Data
Dec. 16, 2003 (FR) 0351071

(51) Int. Cl. A01G 1/08

(52) U.S. Cl. 47/33; 47/1.01 R

(57) ABSTRACT

A defensive anti-intrusion vegetal hedge for the protection of a property, incorporating plants having spines or similar, wherein said plants are planted along a line defining the area to be protected, in one or two rows, characterized in that the branches of said plants are linked to neighboring plants by interweaving said branches and/or by binding said branches by the ends thereof, further characterized in that it incorporates framing elements having pointed and/or cutting parts.

### BACKGROUND OF THE INVENTION

(1) Field of the Invention

The object of this invention is a defensive anti-intrusion vegetal hedge for the protection of a property, and the method for the production thereof.

(2) Description of the Prior Art

For quite a long time now, hedges of thorny or non-thorny plants have been used for encircling and delimiting plots of land. This technique was used in the past, in particular in the field of breeding in order to mark out a piece of land and contain a herd.

Some people have already used plantations of thorny plants to protect a private piece of land, without however being able to combine effectiveness, esthetics and resistance to various attempts of crossing, penetration, and destruction.

Besides, hedges resulting from the simple planting of thorny plants do not have a sufficiently deterrent character to be effective.

From DE 195 02 051 is known a vegetal wall designed to be used for delimiting residential areas, sports facilities and playgrounds, but the objective of such a vegetal wall is to make a noise-reducing screen, so it is by no means adapted to prevent crossing.

Also known, through DE 21 39 813, is a wall comprising plants, designed to delimit certain areas, and more specifically to be installed by the roadside of areas abounding in game, in order to avoid accidents caused by game crossing said roads. The object of this invention is to make an esthetic wall fitting perfectly in the landscape, and consisting of a fence made of a wire mesh colonized by plants. The resistance to crossing of such a wall is only connected with that of the wire mesh used, which is not reinforced.

Also known, through DE 386 940, is a snow protection hedge, whose object is to obtain a watertight wall resistant to uprooting, by means of plants weaving. Such a hedge can in no way constitute an anti-intrusion obstacle.

### SUMMARY OF THE INVENTION

The object of this invention is to provide a defensive anti-intrusion vegetal hedge incorporating in particular thorny plants, permitting to achieve the abovementioned objective, and to cope with the abovementioned disadvantages.

The defensive anti-intrusion vegetal hedge according to the invention is of the type incorporating plants having spines or the like, and it is mainly characterized in that said plants are planted along a line defining the area to be protected, in one or two rows; in that the branches of said plants are linked to branches of neighboring plants by interweaving said branches and/or by binding them by the ends thereof; and in that it incorporates framing elements having pointed and/or cutting parts.

According to an additional feature of the device according to the invention, it includes several rows of plants, planted while maintaining a staggered shifting between the rows.

According to an additional feature of the device according to the invention, the thorny plants used consist of plants cultivated in clumps.

According to another additional feature of the device according to the invention, the branches of the plants are linked to and/or interwoven with framing elements.

According to another additional feature of the device according to the invention, the framing elements consist of dry vegetal material.

According to another additional feature of the device according to the invention, the dry vegetal material consists of thorny species that are cut, dried and treated with, in particular, insecticidal, fungicidal, and preservation products.

According to another additional feature of the device according to the invention, the framing elements consist of metallic elements.

According to another additional feature of the device according to the invention, the metallic elements are in the form of barbed wire, concertina wire or the like, arranged in spirals inserted between the plants or into the latter.

According to another additional feature of the device according to the invention, it includes mineral elements partially driven into the ground.

According to another additional feature of the device according to the invention, it includes metallic framing elements anchored in the ground to which the thorny plants can be linked solidly through wire means.

According to the invention, the method for the production of the defensive anti-intrusion vegetal hedge consists in planting plants having spines or the like along a line defining the area to be protected, in one or two rows, eventually incorporating framing elements therein, then in linking the branches of said plants to branches of neighboring plants and/or to said possible framing elements, by means of interweaving and/or binding.

According to an additional feature of the method according to the invention, before the operation of interweaving and/or binding of the branches, at least a portion of the latter is bent in order to be oriented substantially horizontally.

According to another additional feature of the method according to the invention, the branches are incised in order to facilitate their bending.

### DETAILED DESCRIPTION OF THE PREFERRED EMBODIMENTS

Depending on the degree of protection that one would like to achieve, the hedge device according to the invention includes one or several of the above-mentioned features.

The advantages and the features of the device according to the invention will become clearer from the following description.

The production of a defensive hedge according to the invention requires, after an appropriate preparation of the soil, of course, the planting of plants having spines or the like, that can be chosen, for example, and not restrictively, among the following species: zanthoxyllum, gleditsias triacanthos, gleditsias horrida, poncirius trifoliata, maclura pomifera, crataegus monogyna, crataegus crus-galli, crataegus oxyacantha, berberis, paliurus spina christi, prunus spinosa, as well as the various varieties of said species.

If the hedge also requires the creation of a visual screen, it could also be composed of plants chosen for example, and not restrictively, among the following species: berberis julianae, prunus lusitanica, osmanthus, ilex, quercus coccifera, mahoberberis, rosa, rubus, buxus, viburnum.

It should be noted that some of the abovementioned plants, usually cultivated as trees, as saplings or on a ramified branch, are advantageously, for the purposes of this invention, cultivated in clumps on several branches in order to favor the development of branches, in particular from the base.

These plants are planted according to a straight, broken, curved or sinuous line, on one or, preferably, several rows, maintaining a certain distance, which constitutes a compromise between the one necessary for the perfect development of the plants, and the one necessary for the construction of an insuperable hedge. Besides, when several rows are planted, the plants of a row are shifted in staggered rows with respect to the plants of the neighboring row or rows.

Furthermore, one can combine different species depending on the desired result, this combination being however, preferably, for a hedge extending on several rows.

The hedge thus constituted can be completed by adding framing elements that can consist of metallic elements, dry plants, or mineral elements.

The metallic elements can be in the form of barbed wire, concertina wire or the like, preferably arranged in spirals inserted between the plants and/or inside the clumps. They can also include pegs or stakes, joined together or not, to which the plants can be attached, at their base, by means of wire elements, such as, for example, fastening ropes.

The dry plants can consist of branches of plants having needles or spines, dried and treated, which are preferably arranged in different directions with respect to those of the living plants.

The mineral elements can consist of blocks of rock, concrete, or the like, more or less driven into the ground, and capable of constituting an obstacle that can block the progression of a vehicle.

The following step of the production of a hedge according to the invention, consists in interweaving the branches of the plants with branches of the neighboring plants, or if they cannot be interwoven, in binding them by means of a bond.

This step can also include, in case of incorporation of framing elements, interweaving or binding the branches of the plants with said framing elements.

The operation of interweaving or binding the branches with each other or with framing elements, is performed by favoring a substantially horizontal orientation of said branches for at least a portion of the latter, by bending them, after incision, if necessary, in case the branches are too thick to be bent easily.

It should be noted that during the production of the hedge according to the invention, interweaving is preferred over binding, considering that the latter is made by means of a bond that can have the disadvantage of strangling the branches. Thus, binding is rather for the ends of the branches, in order to attach the latter to the ends of other branches or to metallic or non-metallic framing elements.

The operation of interweaving is performed preferably commencing with the branches of the lower part of the plants, then going up progressively, so that the hedge has a good base, considering that the upper part can subsequently be comprised of newly grown branches. In this connection, it should be noted that during the regular maintenance of the hedge, the new branches can, preferably, be interwoven and/or attached.

It should also be noted that it is preferable to contemplate a preventive treatment of the soil, or similar, such as a mineral, synthetic, or organic mulching, in order to avoid the drying up of the latter, as well as the growth of weeds.

A hedge according to the invention can, according to the relevant chosen features and options, have a great resistance, and be insuperable, even for a current type vehicle.

Different arrangements can also be made, as for example the planting, on one side of the hedge or on both sides, of a row of non-thorny plants, permitting to prevent people getting accidentally into contact with the hedge from getting hurt.

Advantageously, the hedge according to the invention can incorporate means for detecting presence of all kinds, in particular electronic ones.

Besides, the preceding description refers to the creation of a hedge, but it can also be used on an existing hedge or as a complement to a wall or other fencing elements.

1. Defensive anti-intrusion vegetal hedge of the type incorporating plants having spines or the like, wherein said plants are planted along a line defining the area to be protected, in one or two rows; wherein the branches of said plants are linked to branches of neighboring plants by interweaving said branches and/or by binding said branches by the ends thereof; and wherein it incorporates framing elements having pointed and/or cutting parts.

2. Defensive vegetal hedge according to claim 1, wherein it includes several rows of plants, planted while maintaining a gap in staggered shifting between the rows.

3. Defensive vegetal hedge according to claim 1, wherein the thorny plants used consist of plants cultivated in clumps.

4. Defensive vegetal hedge according to claim 1, wherein the branches of the plants are linked and/or interwoven with the framing elements.

5. Defensive vegetal hedge according to claim 1, wherein the framing elements consist of dry vegetal material.

6. Defensive vegetal hedge according to claim 5, wherein the dry vegetal material consists of thorny species cut, dried and treated with, in particular, insecticidal, fungicidal, and preservation products.

7. Defensive vegetal hedge according to claim 1, wherein the framing elements consist of metallic elements.

8. Defensive vegetal hedge according to claim 7, wherein the metallic elements are in the form of barbed wire, concertina wire or the like, arranged in spirals inserted between the plants or into the latter.

9. Defensive vegetal hedge according to claim 1, wherein it includes mineral elements partially driven into the ground.

10. Defensive vegetal hedge according to claim 1, wherein it includes metallic framing elements anchored in the ground to which the thorny plants can be linked solidly through wire means.

11. Defensive hedge according to claim 1, wherein it incorporates means for detecting presence.

12. Method for the production of a defensive anti-intrusion vegetal hedge according to claim 1, wherein it consists in planting plants having spines or the like along a line delimiting the area to be protected, in one or two rows, possibly incorporating framing elements therein, then in linking the branches of said plants to branches of neighboring plants and/or to said eventual framing elements, by means of weaving and/or binding.

13. Method according to claim 12, wherein, before the operation of binding and/or interweaving of the branches, at least a portion of the latter is bent in order to be oriented substantially horizontally, after an eventual incision thereof.
